(19) United States
(12) Patent Application Publication
(10) Pub. No.: US 2013/0126324 A1
(43) Pub. Date: May 23, 2013

(54) KEYBOARD WITH Z-SHAPED SUPPORT MEMBER

(71) Applicant: Darfon Electronics Corp., Taoyuan (TW)

(72) Inventors: Chih-Hsiang Chiang, Taoyuan (TW); Fei-Ya Chen, Taoyuan (TW)

(73) Assignee: DARFON ELECTRONICS CORP., Taoyuan (TW)

(21) Appl. No.: 13/671,560

(22) Filed: Nov. 8, 2012

(30) Foreign Application Priority Data
Nov. 22, 2011 (TW) 100222049

(51) Int. Cl. H01H 13/70; H01H 13/84

(52) U.S. Cl. 200/5 A

(57) ABSTRACT

A keyboard includes a base and a plurality of keyswitches. The keyswitches are disposed on the base. One of the keyswitches includes a key cap, a first support member and a second support member. The first support member is Z-shaped and has a first sliding portion and a first rotating portion, wherein the first sliding portion is selectively disposed on one of the base and the key cap and the first rotating portion is selectively disposed on the other one of the base and the key cap. The second support member is Z-shaped and has a second sliding portion and a second rotating portion, wherein the second sliding portion is selectively disposed on one of the base and the key cap and the second rotating portion is selectively disposed on the other one of the base and the key cap.

### BACKGROUND OF THE INVENTION

1. Field of the Invention

The invention relates to a keyboard and, more particularly, to a keyboard utilizing at least two Z-shaped support members to support a key cap.

2. Description of the Prior Art

A keyboard, which is the most common input device, can be found in variety of electronic equipments for users to input characters, symbols, numerals and so on. From consumer electronic products to industrial machine tools are all equipped with a keyboard for purpose of operation.

Referring to FIG. 1, FIG. 1 is a cross-sectional view illustrating a keyswitch 1 of the prior art. As shown in FIG. 1, the keyswitch 1 comprises a base 10, a key cap 12, a circuit board 14, a lift support device 16 and a resilient member 18. The circuit board 14 is disposed on the base 10. The lift support device 16 is disposed between the key cap 12 and the base 10 and used for supporting the key cap 12. The resilient member 18 is also disposed between the key cap 12 and the base 10. After the key cap 12 is pressed by a user, the resilient member 18 provides an elastic force for the key cap 12 so as to make the key cap 12 return to the original position.

As shown in FIG. 1, the key cap 12 has a sliding groove 120 and an engaging groove 122, the base 10 has a sliding groove 100 and an engaging groove 102, and the lift support device 16 comprises a support member 160 and a support member 162. One end of the support member 160 is slidably disposed in the sliding groove 120 and the other end of the support member 160 is pivotally disposed in the engaging groove 102. One end of the support member 162 is slidably disposed in the sliding groove 100 and the other end of the support member 162 is pivotally disposed in the engaging groove 122. Accordingly, the key cap 12 can move toward the base 10 along with the lift support device 16. However, the aforesaid mechanism of the conventional lift support device 16 will increase height of the keyswitch 1 and the structure thereof is much more complicated such that the use of the keyswitch 1 is limited.

### SUMMARY OF THE INVENTION

Therefore, an objective of the invention is to provide a keyboard utilizing at least two Z-shaped support members to support a key cap so as to solve the aforesaid problems.

According to an embodiment of the invention, a keyboard comprises a base and a plurality of keyswitches. The keyswitches are disposed on the base. One of the keyswitches comprises a key cap, a first support member and a second support member. The first support member is Z-shaped and has a first sliding portion and a first rotating portion, wherein the first sliding portion is selectively disposed on one of the base and the key cap and the first rotating portion is selectively disposed on the other one of the base and the key cap. The second support member is Z-shaped and has a second sliding portion and a second rotating portion, wherein the second sliding portion is selectively disposed on one of the base and the key cap and the second rotating portion is selectively disposed on the other one of the base and the key cap.

According to another embodiment of the invention, a keyboard comprises a base, a backlight module and a plurality of keyswitches. The backlight module is disposed at a first side of the base. The keyswitches are disposed at a second side of the base. One of the keyswitches comprises a key cap, a first support member and a second support member. The first support member is Z-shaped and has a first sliding portion and a first rotating portion, wherein the first sliding portion is selectively disposed on one of the base and the key cap and the first rotating portion is selectively disposed on the other one of the base and the key cap. The second support member is Z-shaped and has a second sliding portion and a second rotating portion, wherein the second sliding portion is selectively disposed on one of the base and the key cap and the second rotating portion is selectively disposed on the other one of the base and the key cap.

As mentioned in the above, the invention replaces the conventional lift support device by the Z-shaped first support member and the Z-shaped second support member, wherein the two Z-shaped support members not only have simple structure but also save much more space for the keyboard. Furthermore, the keyboard of the invention can be equipped with the backlight module so as to form a light keyboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view illustrating a keyswitch of the prior art.

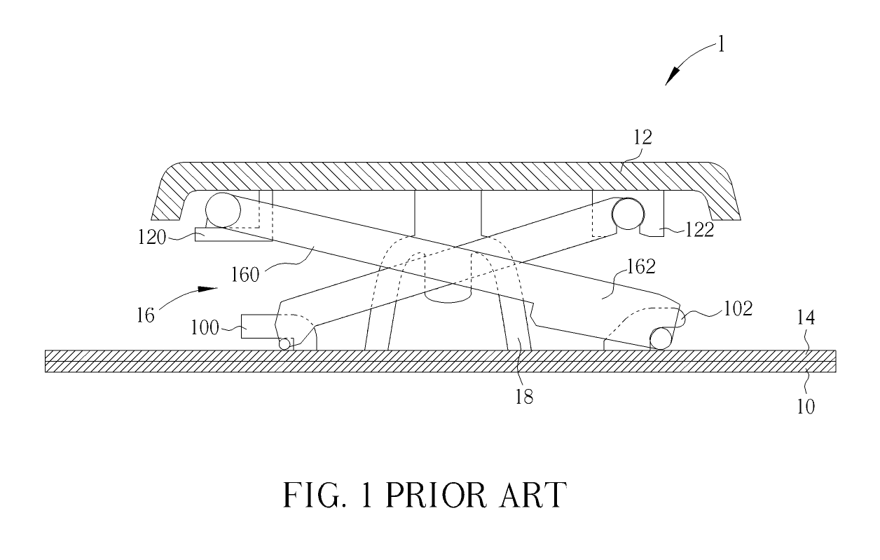

FIG. 2 is a schematic diagram illustrating a keyswitch according to an embodiment of the invention.

FIG. 3 is an exploded view illustrating the keyswitch shown in FIG. 2.

FIG. 4 is a top view illustrating the keyswitch shown in FIG. 2.

FIG. 5 is a bottom view illustrating the base and the backlight module removed from the keyswitch shown in FIG. 2.

FIG. 6 is a schematic diagram illustrating the key cap of the keyswitch shown in FIG. 2 being pressed.

FIG. 7 is a top view illustrating a keyswitch according to another embodiment of the invention.

FIG. 8 is a top view illustrating a keyswitch according to another embodiment of the invention.

FIG. 9 is a schematic diagram illustrating a keyboard according to another embodiment of the invention.

FIG. 10 is a schematic diagram illustrating a keyswitch according to another embodiment of the invention.

FIG. 11 is a schematic diagram illustrating a support device according to another embodiment of the invention.

### DETAILED DESCRIPTION

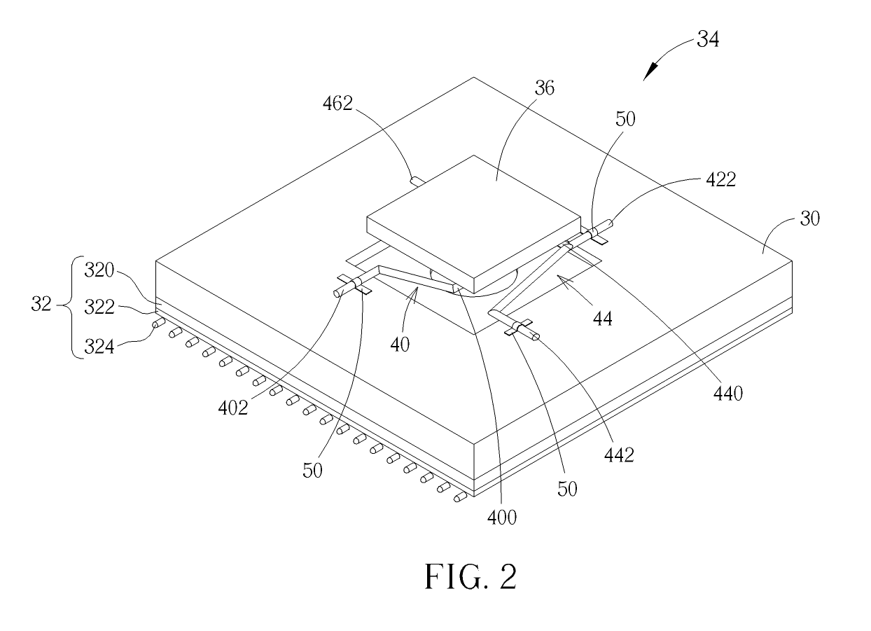

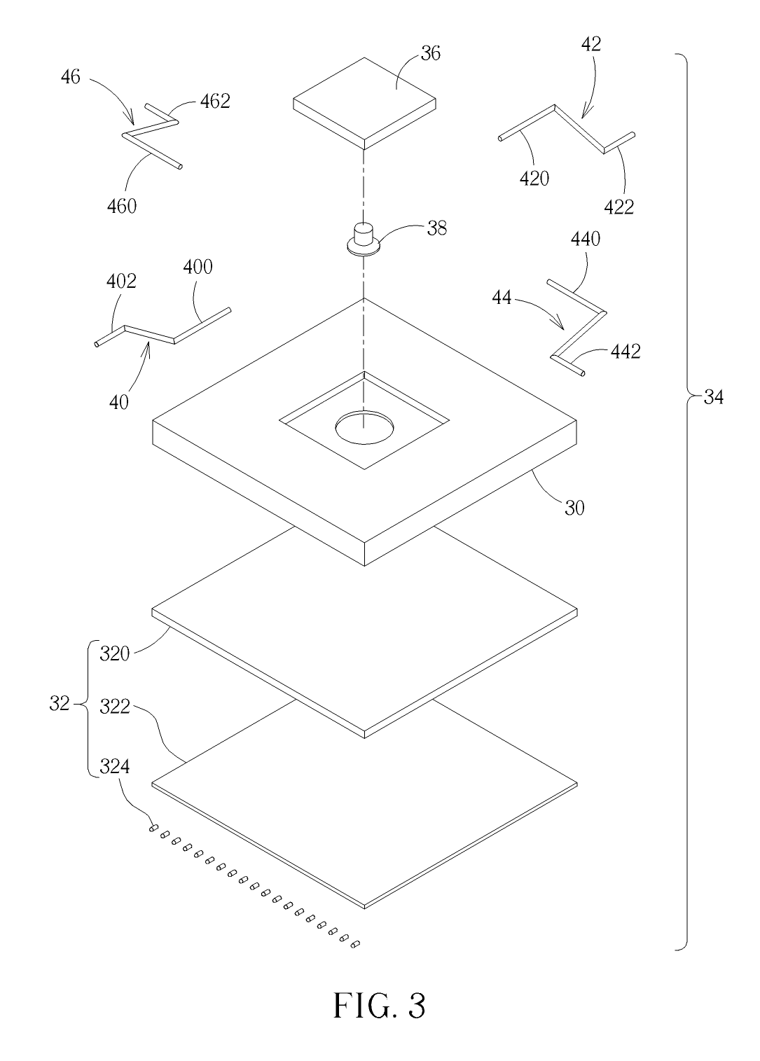

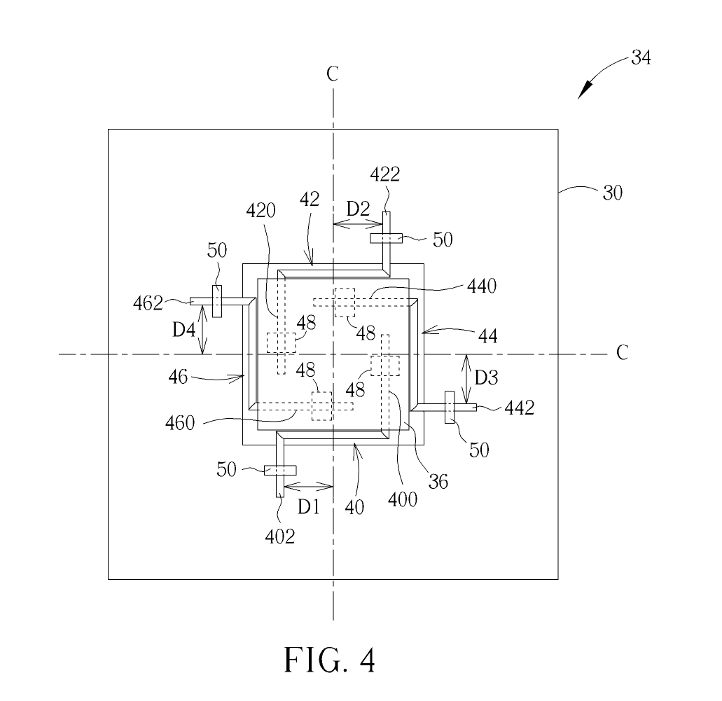

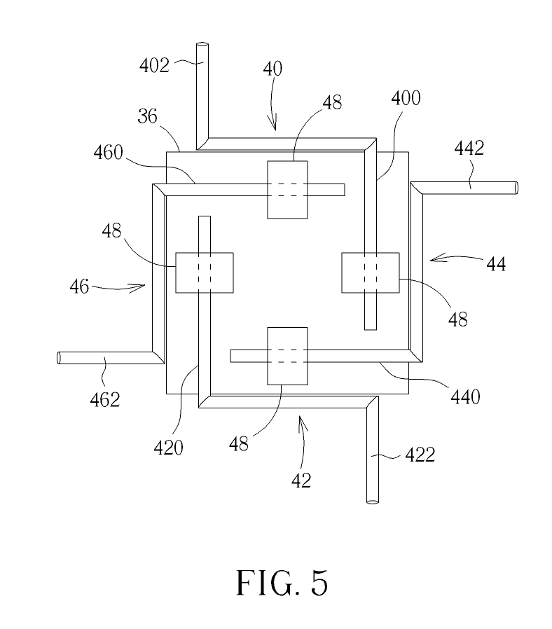

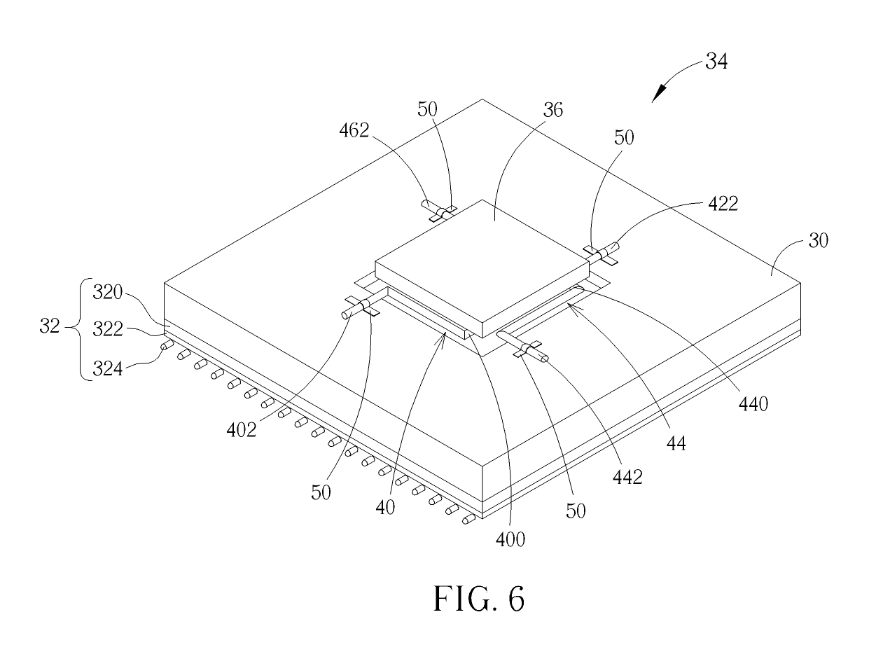

Referring to FIGS. 2 to 6, FIG. 2 is a schematic diagram illustrating a keyswitch 34 according to an embodiment of the invention, FIG. 3 is an exploded view illustrating the keyswitch 34 shown in FIG. 2, FIG. 4 is a top view illustrating the keyswitch 34 shown in FIG. 2, FIG. 5 is a bottom view illustrating the base 30 and the backlight module 32 removed from the keyswitch 34 shown in FIG. 2, and FIG. 6 is a schematic diagram illustrating the key cap 36 of the keyswitch 34 shown in FIG. 2 being pressed. As shown in FIGS. 2 to 6, the keyswitch 34 comprises a base 30, a backlight module 32, a key cap 36, a resilient member 38, a first support member 40, a second support member 42, a third support member 44 and a fourth support member 46.

The backlight module 32 is disposed at a first side S1 of the base 30 and the key cap 36 is disposed at a second side S2 of the base 30. In this embodiment, the backlight module 32 comprises a light guide plate 320, a reflective sheet 322 and at least one light emitting unit 324. In practical applications, a hole can be formed on the base 30 such that light emitted by the backlight module 32 can be projected toward the key cap 36. Furthermore, at least one part of the key cap 36 is transparent such that light can pass through the transparent part so as to be seen by a user. In practical applications, the key cap 36 may be made of transparent material or a partial transparent region may be formed on the key cap 36 by plastic injection molding. The principle of the backlight module 32 is well known by one skilled in the art so it will not be depicted herein.

The resilient member 38 is disposed between the key cap 36 and the base 30. In practical applications, a circuit board (e.g. membrane circuit board, not shown) is disposed on the base 30 and has a switch thereon corresponding to the keyswitch 34. When the key cap 36 of the keyswitch 34 is pressed, the switch of the circuit board is triggered so as to execute related function. Furthermore, the resilient member 38 may be a rubber dome or a metal dome based on practical applications. After the key cap 36 is pressed by the user, the resilient member 38 provides an elastic force for the key cap 36 so as to make the key cap 36 return to the original position.

In this embodiment, the first support member 40, the second support member 42, the third support member 44 and the fourth support member 46 all are Z-shaped and disposed at four sides of the key cap 36, respectively. As shown in FIG. 3, the first support member 40 has a first sliding portion 400 and a first rotating portion 402, the second support member 42 has a second sliding portion 420 and a second rotating portion 422, the third support member 44 has a third sliding portion 440 and a third rotating portion 442, and the fourth support member 46 has a fourth sliding portion 460 and a fourth rotating portion 462. In this embodiment, the first sliding portion 400, the second sliding portion 420, the third sliding portion 440 and the fourth sliding portion 460 all are disposed on the key cap 36 by adhesion, and the first rotating portion 402, the second rotating portion 422, the third rotating portion 442 and the fourth rotating portion 462 all are disposed on the base 30 by adhesion. As shown in FIG. 5, the first sliding portion 400, the second sliding portion 420, the third sliding portion 440 and the fourth sliding portion 460 all are slidably fixed on the key cap 36 by adhesive members 48. As shown in FIG. 4, the first rotating portion 402, the second rotating portion 422, the third rotating portion 442 and the fourth rotating portion 462 all are rotatably fixed on the base 30 by adhesive members 50. In this embodiment, the aforesaid adhesive members 48 and 50 may be hot melt adhesive, UV adhesive or other adhesive members. Some space has to be retained in the adhesive members 48, which are formed on the first sliding portion 400, the second sliding portion 420, the third sliding portion 440 and the fourth sliding portion 460, such that the first sliding portion 400, the second sliding portion 420, the third sliding portion 440 and the fourth sliding portion 460 can slide while the key cap 36 is being pressed. Furthermore, before forming the adhesive members 48 and 50, a release agent may be coated on the first sliding portion 400, the second sliding portion 420, the third sliding portion 440, the fourth sliding portion 460, the first rotating portion 402, the second rotating portion 422, the third rotating portion 442 and the fourth rotating portion 462 in advance, so as to ensure that the aforesaid sliding portions and rotating portions can slide and rotate smoothly.

However, in another embodiment, the first sliding portion 400, the second sliding portion 420, the third sliding portion 440 and the fourth sliding portion 460 all may be disposed on the base 30 by adhesion, and the first rotating portion 402, the second rotating portion 422, the third rotating portion 442 and the fourth rotating portion 462 all may be disposed on the key cap 36 by adhesion. In other words, the first sliding portion 400 can be selectively disposed on one of the base 30 and the key cap 36 and the first rotating portion 402 can be selectively disposed on the other one of the base 30 and the key cap 36; the second sliding portion 420 can be selectively disposed on one of the base 30 and the key cap 36 and the second rotating portion 422 can be selectively disposed on the other one of the base 30 and the key cap 36; the third sliding portion 440 can be selectively disposed on one of the base 30 and the key cap 36 and the third rotating portion 442 can be selectively disposed on the other one of the base 30 and the key cap 36; the fourth sliding portion 460 can be selectively disposed on one of the base 30 and the key cap 36 and the fourth rotating portion 462 can be selectively disposed on the other one of the base 30 and the key cap 36.

As shown in FIG. 4, the first support member 40 and the second support member 42 are disposed at opposite sides of the key cap 36, respectively, the first sliding portion 400 is parallel to the second sliding portion 420, and the first rotating portion 402 is parallel to the second rotating portion 422; the third support member 44 and the fourth support member 46 are disposed at another opposite sides of the key cap 36, respectively, the third sliding portion is parallel to the fourth sliding portion 460, and the third rotating portion 442 is parallel to the fourth rotating portion 462. In this embodiment, the first sliding portion 400 is parallel to the first rotating portion 402, the second sliding portion 420 is parallel to the second rotating portion 422, the third sliding portion 440 is parallel to the third rotating portion 442, and the fourth sliding portion 460 is parallel to the fourth rotating portion 462. It should be noted that the invention is not limited to the aforesaid embodiment as long as the key cap 36 can move with respect to the base 30. Moreover, a perpendicular distance D1 between the first rotating portion 402 and the center line C of the key cap 36, a perpendicular distance D2 between the second rotating portion 422 and the center line C of the key cap 36, a perpendicular distance D3 between the third rotating portion 442 and the center line C of the key cap 36, and a perpendicular distance D4 between the fourth rotating portion 462 and the center line C of the key cap 36 are equal to each other. Accordingly, the key cap 36 can move with respect to the base 30 stably and smoothly.

When the key cap 36 is being pressed, the first sliding portion 400, the second sliding portion 420, the third sliding portion 440 and the fourth sliding portion 460 will slide within the adhesive members 48 correspondingly and the first rotating portion 402, the second rotating portion 422, the third rotating portion 442 and the fourth rotating portion 462 will rotate within the adhesive members 50 correspondingly such that the key cap 36 can move with respect to the base 30 stably and smoothly. After an external force, which presses the key cap 36, is released, the resilient member 38 provides an elastic force for the key cap 36 so as to make the key cap 36 return to the original position.

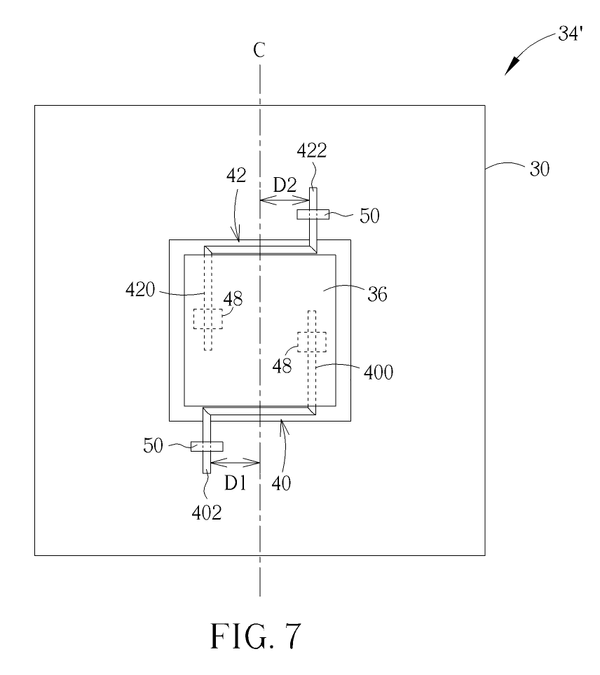

Referring to FIG. 7, FIG. 7 is a top view illustrating a keyswitch 34′ according to another embodiment of the invention. The main difference between the keyswitch 34′ and the aforesaid keyswitch 34 is that the keyswitch 34′ does not comprise the aforesaid third support member 44 and fourth support member 46. In other words, the keyswitch 34′ utilizes the first support member 40 and the second support member 42, which are disposed at opposite sides of the key cap 36, to enable the key cap 36 to move with respect to the base 30 stably and smoothly while the key cap 36 is pressed. It should be noted that the same elements in FIG. 7 and FIG. 4 are represented by the same numerals, so the repeated explanation will not be depicted herein again.

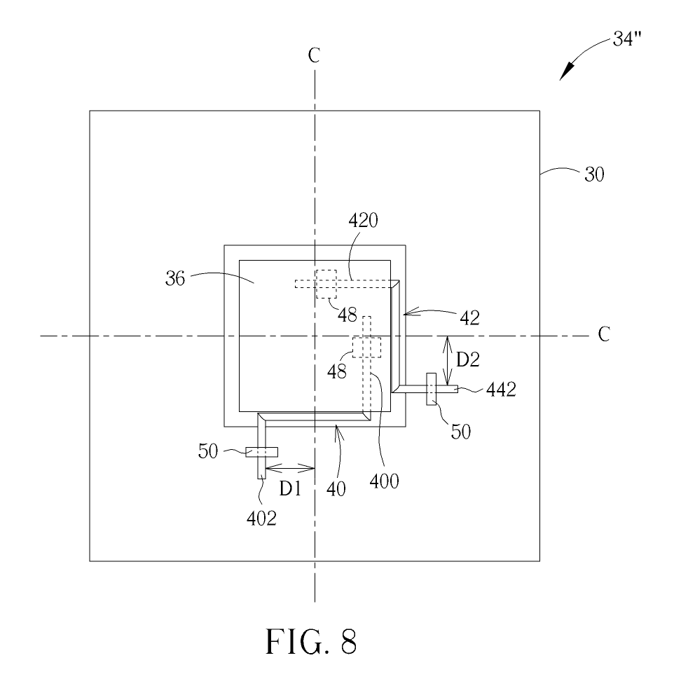

Referring to FIG. 8, FIG. 8 is a top view illustrating a keyswitch 34″ according to another embodiment of the invention. The main difference between the keyswitch 34″ and the aforesaid keyswitch 34′ is that the keyswitch 34″ utilizes the first support member 40 and the second support member 42, which are disposed at adjacent sides of the key cap 36, to enable the key cap 36 to move with respect to the base 30 stably and smoothly while the key cap 36 is pressed. At this time, the first rotating portion 402 is perpendicular to the second rotating portion 422. It should be noted that the same elements in FIG. 8 and FIG. 4 are represented by the same numerals, so the repeated explanation will not be depicted herein again.

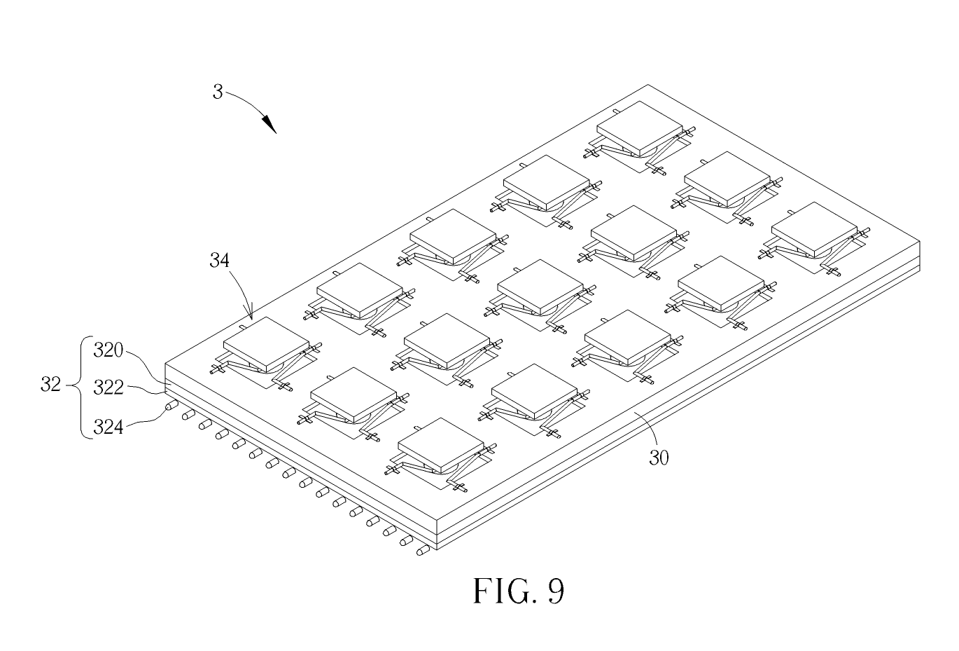

Referring to FIG. 9, FIG. 9 is a schematic diagram illustrating a keyboard 3 according to another embodiment of the invention. As shown in FIG. 9, the keyboard 3 comprises a base 30, a backlight module 32 and a plurality of keyswitches 34. The backlight module 32 is disposed at a first side S1 of the base 30 and the keyswitches 34 are disposed at a second side S2 of the base 30. It should be noted that the arrangement and principle of the base 30, the backlight module 32 and the keyswitches 34 are mentioned in the above and will not be depicted herein again. Furthermore, each of the keyswitches 34 may be replaced by the aforesaid keyswitch 34′ or keyswitch 34″.

The aforesaid keyswitch 34, keyswitch 34′ or keyswitch 34″ may be also used as one single switch except be applied to the keyboard.

Still further, in another embodiment, the aforesaid base 30 may be a light guide base. In other words, the base 30 can be used to guide light itself so the backlight module 32 does not need the aforesaid light guide plate 320.

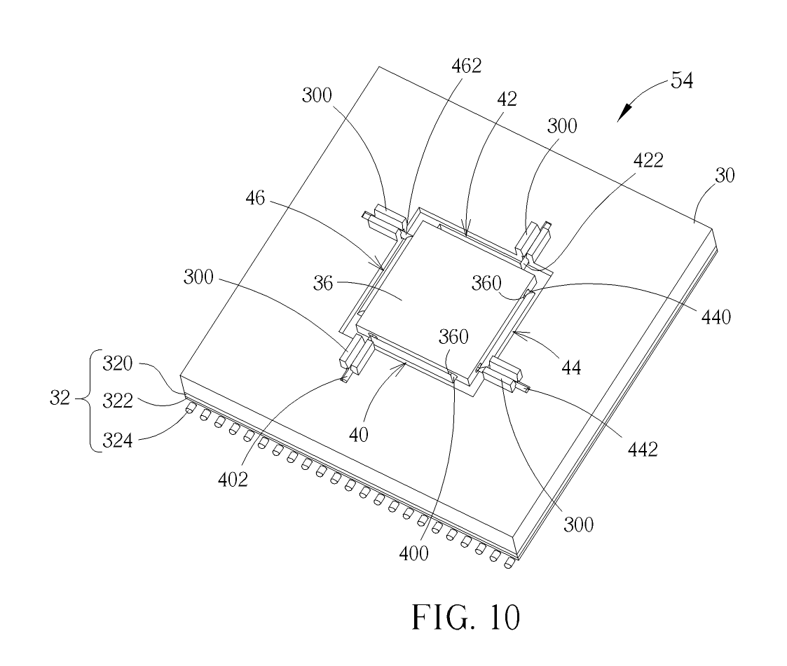

Referring to FIG. 10, FIG. 10 is a schematic diagram illustrating a keyswitch 54 according to another embodiment of the invention. The main difference between the keyswitch 54 and the aforesaid keyswitch 34 is that, in the keyswitch 54, the first sliding portion 400, the second sliding portion 420, the third sliding portion 440 and the fourth sliding portion 460 all are disposed on the key cap 36 by engagement, and the first rotating portion 402, the second rotating portion 422, the third rotating portion 442 and the fourth rotating portion 462 all are disposed on the base 30 by engagement. As shown in FIG. 10, the first sliding portion 400, the second sliding portion 420, the third sliding portion 440 and the fourth sliding portion 460 are slidably engaged in sliding grooves 360 of the key cap 36, and the first rotating portion 402, the second rotating portion 422, the third rotating portion 442 and the fourth rotating portion 462 are rotatably engaged in engaging grooves 300 of the base 30. The sliding grooves 360 may be designed as, but not limited to, oval-like shape such that the first sliding portion 400, the second sliding portion 420, the third sliding portion 440 and the fourth sliding portion 460 can slide while the key cap 36 is pressed. However, in another embodiment, the first sliding portion 400, the second sliding portion 420, the third sliding portion 440 and the fourth sliding portion 460 may be also rotatably engaged in engaging grooves (not shown) of the key cap 36, and the first rotating portion 402, the second rotating portion 422, the third rotating portion 442 and the fourth rotating portion 462 may be also slidably engaged in sliding grooves (not shown) of the base 30. It should be noted that the same elements in FIG. 10 and FIG. 4 are represented by the same numerals, so the repeated explanation will not be depicted herein again.

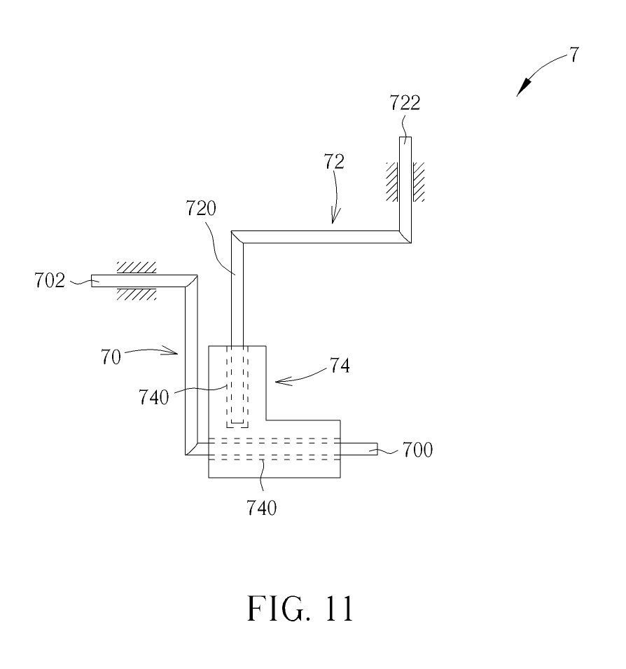

Referring to FIG. 11, FIG. 11 is a schematic diagram illustrating a support device 7 according to another embodiment of the invention. As shown in FIG. 11, the support device 7 comprises a first support member 70, a second support member 72 and a sleeve member 74. The first support member 70 is Z-shaped and has a first sliding portion 700 and a first rotating portion 702. The second support member 72 is Z-shaped and has a second sliding portion 720 and a second rotating portion 722. The first support member 70 is disposed adjacent to the second support member 72 and the first rotating portion 702 is perpendicular to the second rotating portion 722. In practical applications, the first rotating portion 702 and the second rotating portion 722 can be rotatably disposed on a base (e.g. the aforesaid base 30). The sleeve member 74 is sleeved on the first sliding portion 700 and the second sliding portion 720. In this embodiment, the first sliding portion 700 and the second sliding portion 720 are inserted into sliding grooves 740 of the sleeve member 74, respectively. The sliding grooves 740 may be designed as, but not limited to, oval-like shape such that the first sliding portion 700 and the second sliding portion 720 can slide therein.

Compared with the prior art, the invention replaces the conventional lift support device by the Z-shaped support members, wherein the Z-shaped support members not only have simple structure but also save much more space for the keyboard. Furthermore, the keyboard of the invention can be equipped with the backlight module so as to form a light keyboard.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard comprising:
a base; and
a plurality of keyswitches disposed on the base, one of the keyswitches comprising:
a key cap;
a first support member, the first support member being Z-shaped and having a first sliding portion and a first rotating portion, wherein the first sliding portion is selectively disposed on one of the base and the key cap and the first rotating portion is selectively disposed on the other one of the base and the key cap; and
a second support member, the second support member being Z-shaped and having a second sliding portion and a second rotating portion, wherein the second sliding portion is selectively disposed on one of the base and the key cap and the second rotating portion is selectively disposed on the other one of the base and the key cap.

2. The keyboard of claim 1, wherein the first sliding portion is selectively disposed on one of the base and the key cap by adhesion or engagement and the first rotating portion is selectively disposed on the other one of the base and the key cap by adhesion or engagement; the second sliding portion is selectively disposed on one of the base and the key cap by adhesion or engagement and the second rotating portion is selectively disposed on the other one of the base and the key cap by adhesion or engagement.

3. The keyboard of claim 1, wherein a perpendicular distance between the first rotating portion and a center line of the key cap is equal to a perpendicular distance between the second rotating portion and the center line of the key cap.

4. The keyboard of claim 1, wherein the keyswitch further comprises:
a third support member, the third support member being Z-shaped and having a third sliding portion and a third rotating portion, wherein the third sliding portion is selectively disposed on one of the base and the key cap and the third rotating portion is selectively disposed on the other one of the base and the key cap; and
a fourth support member, the fourth support member being Z-shaped and having a fourth sliding portion and a fourth rotating portion, wherein the fourth sliding portion is selectively disposed on one of the base and the key cap and the fourth rotating portion is selectively disposed on the other one of the base and the key cap;
wherein the first support member, the second support member, the third support member and the fourth support member are disposed at four sides of the key cap, respectively.

5. A keyboard comprising:
a base;
a backlight module disposed at a first side of the base; and
a plurality of keyswitches disposed at a second side of the base, one of the keyswitches comprising:
a key cap;
a first support member, the first support member being Z-shaped and having a first sliding portion and a first rotating portion, wherein the first sliding portion is selectively disposed on one of the base and the key cap and the first rotating portion is selectively disposed on the other one of the base and the key cap; and
a second support member, the second support member being Z-shaped and having a second sliding portion and a second rotating portion, wherein the second sliding portion is selectively disposed on one of the base and the key cap and the second rotating portion is selectively disposed on the other one of the base and the key cap.

6. The keyboard of claim 5, wherein the base is a light guide base and the backlight module comprises at least one light emitting unit.

7. The keyboard of claim 5, wherein the first sliding portion is selectively disposed on one of the base and the key cap by adhesion or engagement and the first rotating portion is selectively disposed on the other one of the base and the key cap by adhesion or engagement; the second sliding portion is selectively disposed on one of the base and the key cap by adhesion or engagement and the second rotating portion is selectively disposed on the other one of the base and the key cap by adhesion or engagement.

8. The keyboard of claim 5, wherein at least one part of the key cap is transparent.

9. The keyboard of claim 5, wherein a perpendicular distance between the first rotating portion and a center line of the key cap is equal to a perpendicular distance between the second rotating portion and the center line of the key cap.

10. The keyboard of claim 5, wherein the keyswitch further comprises:
a third support member, the third support member being Z-shaped and having a third sliding portion and a third rotating portion, wherein the third sliding portion is selectively disposed on one of the base and the key cap and the third rotating portion is selectively disposed on the other one of the base and the key cap; and
a fourth support member, the fourth support member being Z-shaped and having a fourth sliding portion and a fourth rotating portion, wherein the fourth sliding portion is selectively disposed on one of the base and the key cap and the fourth rotating portion is selectively disposed on the other one of the base and the key cap;
wherein the first support member, the second support member, the third support member and the fourth support member are disposed at four sides of the key cap, respectively.

11. The keyboard of claim 10, wherein the first sliding portion is selectively disposed on one of the base and the key cap by adhesion or engagement and the first rotating portion is selectively disposed on the other one of the base and the key cap by adhesion or engagement; the second sliding portion is selectively disposed on one of the base and the key cap by adhesion or engagement and the second rotating portion is selectively disposed on the other one of the base and the key cap by adhesion or engagement; the third sliding portion is selectively disposed on one of the base and the key cap by adhesion or engagement and the third rotating portion is selectively disposed on the other one of the base and the key cap by adhesion or engagement; the fourth sliding portion is selectively disposed on one of the base and the key cap by adhesion or engagement and the fourth rotating portion is selectively disposed on the other one of the base and the key cap by adhesion or engagement.

12. The keyboard of claim 10, wherein the first support member and the second support member are disposed at opposite sides of the key cap, respectively, and the first rotating portion is parallel to the second rotating portion; the third support member and the fourth support member are disposed at another opposite sides of the key cap, respectively, and the third rotating portion is parallel to the fourth rotating portion.

13. The keyboard of claim 10, wherein a perpendicular distance between the first rotating portion and a center line of the key cap, a perpendicular distance between the second rotating portion and the center line of the key cap, a perpendicular distance between the third rotating portion and the center line of the key cap, and a perpendicular distance between the fourth rotating portion and the center line of the key cap are equal to each other.

14. The keyboard of claim 10, wherein the first sliding portion is parallel to the first rotating portion, the second sliding portion is parallel to the second rotating portion, the third sliding portion is parallel to the third rotating portion, and the fourth sliding portion is parallel to the fourth rotating portion.
